(19) United States
(12) Patent Application Publication
(10) Pub. No.: US 2014/0278503 A1
(43) Pub. Date: Sep. 18, 2014

(54) SYSTEM AND METHODS FOR TREATMENT AND MANAGEMENT OF ONE OR MORE SUBJECTS

(71) Applicant: The Board of Trustees of the University of Illinois, Urbana, IL (US)

(72) Inventors: Daniel BIRK, Chicago, IL (US); Ugo Alessandro Buy, Oak Park, IL (US); Kevin Samuel Paul, Seattle, WA (US); Christa Wellman, Chicago, IL (US); Fady Charbel, River Forest, IL (US); Sepideh Amin-Hanjani, Chicago, IL (US)

(21) Appl. No.: 14/213,377

(22) Filed: Mar. 14, 2014

Related U.S. Application Data
(60) Provisional application No. 61/784,619, filed on Mar. 14, 2013.

(51) Int. Cl. G06F 19/00

(52) U.S. Cl. CPC G06F 19/3406
USPC 705/2

(57) ABSTRACT

System and methods configured to permit a user such as a health care provider to organize and manage patient information quickly and efficiently from a simplified representation. Such simplified representations may include a patient representation and a context representation. The representations may be updated to represent real-time patient conditions through the input of information directly from treatment or monitoring devices or from user input.

### CROSS REFERENCE TO RELATED APPLICATIONS

This application claims the benefit of U.S. provisional application 61/784,619 filed Mar. 14, 2013, which is incorporated by reference herein in its entirety.

### FIELD OF THE INVENTION

The present invention is directed to a system and methods for treating and managing one or more subjects. Certain embodiments of the invention are directed to patients as the subjects and permit a health care provider to assess and prioritize the treatment provided to a group of patients.

### BACKGROUND OF THE INVENTION

A single health care provider is typically responsible for providing treatment to one or more patients in a certain medical context such as a certain hospital wing, department, or an intensive care unit (“ICU”). The patients for whom the physician is responsible typically require different types and levels of care: one patient may be in need of attention or treatment more than others; some patients may be stable while others are not.

In order for a physician or other health care provider to manage the treatment of such a group of patients, certain systems and methods have been developed. One such system requires that a chart be prepared and managed for each patient. The chart typically contains all the information regarding the patient and the treatment given the patient in a chronological fashion. The chart may be solely analog but may also require the treating physician to make reference to digital content, such as on a computer display. Physicians rendering care in an emergency situation or with critically ill patients often record notes of the status of and the care given each patient on one or more pieces of paper that they carry around during their shift. At the end of the shift, each physician then uses those notes to inform the new physician coming on duty about each patient's status.

Such known systems and methods for managing the care given to patients who may be critically ill have many limitations associated with them. The physician may not have time to review a patient's entire chart before having to make an important decision regarding what care to give to the patient. Instead, a summary of the most important information to which the physician must have access would be invaluable in such a situation. The notes that many physicians take and carry in their pockets is an attempt of having such a readily available summary. But even preparing such hand written notes takes time and may be not as comprehensive as the physician needs in order to make critical treatment decisions. At the end of the shift, the physician often must review the notes with the new physician coming on duty so that there is continuity in care given to the patients being treated.

Accordingly, there is a demand for a system and methods that permits a health care provider to record, have access to, review, and transfer to another health care provider a simple, quick to understand summary of the status and treatment given to one or more patients. The present invention satisfies this demand.

### SUMMARY OF THE INVENTION

For purposes of this application, the present invention is discussed in reference to a health care provider treating and managing one or more patients in a health care facility, but the discussion is merely exemplary. The present invention is applicable to a user who is managing or treating one or more subjects in a wide variety of contexts including, but not limited to, an accident scene, disaster site, or combat zone. The present invention is also applicable to a laboratory technician managing a number of experiments or experimental subjects, a child care provider managing a group of children, or any user who is managing or treating a number of subjects in an environment in which the subjects may have a potentially dynamic or time-sensitive condition.

For purposes of this application, a “health care provider” or “provider” includes a doctor—such as an attending physician, fellow, or resident physician, physician's assistant, nurse practitioner, nurse, pharmacist, physical therapist, medical assistant, emergency responder or any similar personnel who may provide services to aid in the health and/or safety of life. Also for purposes of this application, a “health care facility” may include a clinic, a nursing home, a rehabilitation facility, a hospital, or a department of a hospital such as an ICU, a critical care unit, an emergency room, a labor and delivery ward, nursery, neonatal unit, pediatrics department, a cardiology section, hospice ward, oncology ward, or other inpatient or outpatient departments. However, in an emergency situation, care may be delivered to patients in a variety of other contexts such as outdoors, on the street, in gymnasiums, and in collapsed buildings and, therefore, the term “health care facility” is intended to have a broad meaning. For purposes of this application, examples of a “subject” include a patient such as a human, animal, or other organism, an ecosystem, test subject, chemical reaction, or other.

Certain embodiments of the present invention permit a health care provider to record and obtain information about a subject in a quick and easy manner. In certain embodiments, the health care provider may have only a very limited amount of time to assess a subject or a group of subjects and triage them. With respect to triage, the health care provider must quickly assess the condition of each of a group of subjects, decide which patient should receive treatment first, decide what type of care to deliver to the first and subsequent subjects, perform the chosen procedure on one patient, and manage one or more others who are attempting to assist in the management of care to the subjects, all the while recording such information about the decisions that were made and the care given each subject.

Certain embodiments of the present invention provide a simplified representation of the subject of the treatment and management, termed a “subject representation” or “representation” for purposes of this application. A subject representation may be depicted as a generally two-dimensional shape or may be depicted as a generally three-dimensional shape. Certain embodiments only permit depicting the subject representation as a two-dimensional shape, while other embodiments only permit depicting the subject representation as a three-dimensional shape, while still other embodiments permit the user to select whether one or all subject representations are depicted as a two-dimensional shape or a three-dimensional shape. In embodiments in which a subject representation may be depicted in a three-dimensional shape, such three-dimensional shape may be rotatable such that the user may view the representation from multiple perspectives.

Certain embodiments of the present invention provide what is termed a “context representation”, that is, a simplified representation of the location of one or more subjects relative to the environment such as a room, on a ward, a department, a sidewalk, or other environment. The simplified context representation may depict the subject as a representation or merely a symbol in such location relative to one or more other subjects. Advantageously, the context representation may allow each of the subjects to be identified simply by location.

In certain embodiments, a user may select and position an indicator relative to the display of a subject representation or field by, for example, using a mouse cursor to pick, drag, and drop an indicator typing characters into a field, choosing options from a drop down menu, checking a box field related to choices expressed as text or indicators, selecting a combination of keys (e.g., alt-R, ctrl-T), using a finger or a stylus to write an instruction, code, or abbreviation on a patient representation, voice command, or other methods known in the art. Certain embodiments are configured to permit rapid input of one or more indicators in a short period of time and/or to permit hands-free input of indicators.

Certain embodiments of a subject representation are customizable such that certain characteristics specific to the subject may be conveyed through the representation. Such characteristics may include, for example, gender, age, type of patient (e.g., cat, dog, bird, plant, microbe, human, etc.) or physical attributes such as height, weight, hair color, skin tone, or other. Certain customizable embodiments of a subject representation are termed “avatars”. Certain embodiments of the present invention may permit uploading an actual picture of the subject or a physical attribute of the subject, such as a head/face, arm, leg or other affected and/or treated area of interest. The actual picture may constitute the entire representation, a part of a representation, or a supplementary representation. Advantageously, the customizable representations also may help the health care provider more quickly remember the subject and correlate the system information with the subject. In other embodiments, representations may not be customizable.

Subject representations generally permit a user to quickly identify subject information, such as affected area information, device information, critical information, or provider-focused information. In certain embodiments, an indicator may be displayed to convey subject information.

For purposes of this application, an “indicator” is a symbol, character, icon, figure, color, or visual element configured to convey certain information about the patient. In certain embodiments, an indicator may not include any letters or words, and may include only colors or non-letter symbols. In other embodiments, an indicator may include one or a few letters, but each may be sized, shaped, and configured to be easily and quickly understood by a user. An indicator also may be configured to be easily and quickly added to a subject representation.

Certain embodiments of an indicator may be configured to convey information about a particular area of the subject that is the focus of treatment or management efforts—that is, the “affected area”. Certain embodiments of an affected area indictor may be configured to convey affected area information, and may include a color indicator or a pointer indicator, for example, an outline, arrow, or bull's-eye positioned to identify a specific portion of the subject's body. The affected area indicator and other indicators may be positioned near the affected area displayed in the representation, or may be positioned elsewhere on the display and include sufficient information to determine the affected area by the contents of the indicator. The display of indicators may be updated as soon as possible after a change in a subject's condition such that the representation is as accurate as possible of the actual physical state of the subject. Also, an affected area indicator may include a symptom or ailment indicator, for example, a thermometer for fever, sad face for pain, or specific shape for infection.

Affected area indicators also may include general affected area indicators or specific affected area indicators. Examples of general affected area indicators include a “broken heart” symbol associated with heart conditions, a split bone symbol for a broken bone, or a general lung indicator for an issue with the lungs. Additional examples of general affected area indicators include symbols to represent an organ, such as a brain, eyes, pineal gland, pituitary gland, thyroid gland, parathyroid gland, kidney, liver, pancreas, esophagus, spleen, pleura, thymus gland, adrenal gland, bladder, stomach, gastrointestinal tract, prostate, testes, ovaries, uterus, or organ system, such as circulatory system, nervous system, musculoskeletal system, endocrine system, digestive system, lymphatic system, integumentary system, reproductive system, urinary system, vestibular system, to name a few.

Specific affected area indicators are configured to provide more information than just which area is affected. Examples of specific affected area indicators related to lungs include a lung outline with a striking pattern to identify pulmonary edema, a red saddle-shape to identify pulmonary embolus, ballooned lungs for COPD, and focal black spot for pneumonia.

Certain embodiments of the subject representation also may permit a provider to identify devices that may be applied or are applied to or inserted in the body to provide treatment or for the management of the body. Such devices may include heart monitoring equipment, hemodynamic monitoring equipment including blood pressure and blood flow monitoring equipment, temperature monitoring equipment, oxygen saturation and other respiratory monitoring equipment, assisted breathing apparatuses, neurological monitoring equipment including brain activity monitoring and intracranial pressure monitoring equipment, kidney dialysis equipment, fetal monitoring equipment, blood glucose monitoring, epilepsy monitoring equipment, toxicity monitoring equipment, stress monitoring equipment, orthopedic cast, orthopedic brace, traumatic fracture repair equipment (e.g., screws, pins, plates, and rods), spinal fusion hardware, prosthesis, artificial joint, artificial organ, EEG lead, heart pacemaker, implantable cardioverter defibrillator, implantable port, catheter such as an intravenous catheter, Foley catheter, endotracheal tube, chest tube, feeding tube, Dobhoff tube, drainage tube, stent, or shunt, nasogastric tube, or other tube configured to be inserted into a body cavity, duct, or vessel to allow passage, drainage, or administration of fluids or gases, or access by instruments, or other equipment used to treat or monitor a subject. A device may be identified in the representation by a general device indicator that indicates the presence of some device, but does not specify which type of device, or a specific device indicator configured to specify which device. A device indicator, configured to convey device information may be shown in or near the representation to generally correspond to the actual position in the subject's body—e.g., a feeding tube may be displayed in the abdomen or a brain drainage shunt may be positioned near the head. Any relevant device indicators also may be grouped and shown in a single field. A device indicator also may convey information such as the height of a drain relative to the subject's body.

Certain embodiments of an indicator may include a critical information indicator configured to convey critical information such as vital information or information that indicates a timely response is needed. Such indicators may include a general “alert” indicator or an indicator representative of a specific condition in the subject. Also, to indicate that a timely response is needed or a change in condition has occurred, any or all indicators may blink, increase in size, or otherwise identify a change in condition of the subject. Receiving information about a change in a subject's condition also may trigger another sensory output such as an auditory output, which may include voice, music, or other noise, or a tactile output such as vibration.

Certain embodiments of a critical information indicator may include a priority indicator that shows the priority that the healthcare provider should give each subject healthy history or each subject's status of health and/or safety. The priority indicator may take the form of numbers, letters, colors, or other characters. Such priority may be calculated by a pre-determined set of standards or protocols that permit calculation of an intensity value for each subject's condition, where the intensity value would correlate with the priority of treatment indicator.

Certain embodiments of an indicator may include also a provider-focused indicator configured to convey provider-focused information such as details about treatment, management, devices, or other that are generally most relevant to the provider for assessment or treatment of the subject. Provider-focused information may include a goal that the provider would like the subject to meet, such as blood pressure goal, strength goal, flexibility goal, consistent breathing goal, pain level goal, or heart rate goal, to name a few. In addition, provider-focused information may include information about how long a subject has been in the treatment facility, how long since a subject received a treatment such as surgery, or may identify a primary health care provider or current provider for the subject.

Certain embodiments of the representation also may permit a provider to identify provider-focused information such as treatment information. Treatment information includes details regarding treatment received by the subject. For example, a pharmacy indicator could indicate pharmaceutical treatment, dosage, concentration, contraindications, intake restrictions, or timing of pharmaceutical treatment, past treatments, results of past treatments, or additional information. Examples of a pharmacy indicator may include a general pharmacy indicator to indicate some pharmaceutical treatment or a specific pharmacy indicator to indicate a specific pharmaceutical treatment. The pharmacy indicator may change in form or color at certain steps, e.g., after it has been ordered, obtained, or administered.

Certain embodiments may include an indicator configured to convey the last time any provider assessed the subject or provided any treatment (pharmaceutical or otherwise) to the subject.

In certain embodiments, a provider-focused indicator is configured to provide intake restriction information regarding a patient's allergies, food restrictions, or liquid restrictions (e.g., no liquids before a certain test). Provider-focused information also may include general restrictions, for example, treatment restrictions (e.g., patient has religious opposition to certain procedures or treatments, legal opposition to certain procedures or treatments such as a “do not resuscitate” order), movement restrictions (e.g., patient is highly contagious, patient is bedridden or only allowed out of bed 1 hour a day), or visitor restrictions.

Provider-focused information also may include a task the provider should complete, for example, checking the height of a drain tube, replacing an intravenous fluid bag, intubating the subject, administering a test, obtaining a test result, dispensing a pharmaceutical, conducting a Doppler exam of a limb, providing other treatment, each of which may have a corresponding task indicator or a general task indicator. In certain embodiments, in addition to or instead of displaying task-based provider-focused information as an indicator, the task may be added to a “to do” list component. A to-do list component may be displayed in its own screen accessible via a navigation menu or home screen. Alternatively, a to-do list may materialize as a component of, pop-up, notification, or a secondary information component in the patient representation or context representation.

A to-do list component may be configurable to include only tasks related to a single subject, tasks for a single provider to perform related to a single subject (e.g., first to-do list for nurse related to subject 1, second to-do list for physician related to subject 1), tasks for a single health care provider to do relative to a group of subjects (e.g., health care provider one has first task related to subject 1, second task related to subject 1, third task related to subject 2, fourth task related to subject 3, etc.), or tasks for multiple health care providers to perform relative to one or more subjects.

An entry in a to-do list component may include not only a task element, but also a time element. The time element may permit a user to enter the desired time at which the task should be performed. The desired time may include one specific time (e.g., administer pharmaceutical treatment at 9 AM), multiple specific times (e.g., administer pharmaceutical treatment at 9 AM, 12 PM, and 3 PM), a time range (e.g., administer pharmaceutical treatment between 6 AM and 7 AM), or a specific time or time range relative to a time reference point (e.g., administer pharmaceutical treatment every four hours after first dose). When the time or time range is reached, the system may cause an indicator, pop-up, or other notification to appear relative to the subject representation to remind the user to perform the task. In certain embodiments, a to-do list may include recurring tasks. In such embodiment, upon entering a single task as an entry or adding it as an indicator, the recurring task entries or indicators are automatically generated. In other embodiments, each recurrence of the task must be entered as a separate entry.

An entry in a to-do list component may include not only a task and/or a time element, but also may include a subject element and/or location element. A subject element in a to-do list entry is configured to permit identifying to which subject the task is relevant. Such elements may not be necessary in subject-specific to-do lists, but may be useful in to-do lists configured for a group of one or more subjects. A location element in a to-do list entry is configured to permit associating the task with a specific location (e.g., Bed 1 vs. Bed 2, ICU vs. Emergency Room, etc.).

In certain embodiments, selected tasks may be automatically populated to a to-do list component relative to every subject within a treatment facility department. For example, in an ICU, a lower extremity Doppler exam may be populated to the to-do list for all patients on a biweekly basis. As another example, for every patient admitted to a labor and delivery department, a task entry for checking on the patient's labor progression may be populated to the to-do list for every one hour time increment until a health care provider changes the time element.

Certain embodiments of a to-do list component are configured to rank tasks according to importance, necessity, safety, efficiency, or other objectives of the user. A to-do list component also may be configured to group tasks according to objectives of the user. For example, all tasks related to reviewing radiology images may be grouped such that the health care provider can look at one or more images in a row to save time.

In certain embodiments of a to-do list component, a provider may enter information or create a task entry by typing characters into a field, positioning an indicator relative to a representation or field, selecting options from a drop down menu, checking a box field related to choices expressed as text or indicators, selecting a combination of keys (e.g., alt-R, ctrl-T), using a finger or a stylus to write an instruction, code, or abbreviation on a patient representation, voice command, or other methods known in the art. Certain embodiments are configured to permit rapid input of tasks in a short period of time and/or to permit hands-free input of tasks.

In certain embodiments, one or more indicators may be associated with a secondary information component. A secondary information component may be configured to convey more information than is available by perceiving the indicator alone. Certain embodiments of a secondary information component may include an extended display accessed through, for example, a hover feature (e.g., hovering a mouse cursor or equivalent over an indicator) or a selection feature (e.g., clicking, touching, pushing, hyperlinking, or otherwise choosing the indicator). The secondary information component may permit a user to enter and view individualized information about the patient or the underlying treatment or management efforts with which the indicator is associated relative to the patient. For example, the more detailed information displayed in the secondary information component may include patient images (e.g., X-ray image, ultrasound image, CT scan image, MRI image, or other radiological imaging), non-subject images related to the subject's condition, or descriptions related to the subject). Other embodiments of a secondary information component are configured to permit viewing general, non-individualized information that may be relevant to the indicator or the underlying treatment or management efforts with which it is associated.

Certain embodiments of the present invention are configured to permit depicting a single representation or two or more representations in one screen. In certain embodiments, the provider may choose the number of representations that appear in a screen. Certain embodiments also may permit the provider to determine the relative dimensions of the one or more representations depicted or the system may include one or more pre-set dimensions for depicting one or more representations. Pre-set dimensions may include generally equal sizing of the available screen for each representation (e.g., each representation takes up half of the available screen for two representations, a third of the available screen for three representations, a fourth of the available screen for four representations, etc.). Pre-set dimensions also may include sizing or positioning the representations by highest priority for treatment or review (e.g., patient with most critical need on as the largest depiction, or positioned near top of screen or top layer of screen and patients with less critical needs as smaller depiction, or positioned near middle or bottom of screen or lower layer of screen).

In any embodiment configured to display more than one representation (including context representations or any multiple representation screens) may be configured to permit minimizing the representation. When minimized, certain details (e.g., indicators representing non-critical information, indicators representing non-provider-focused information, or all indicators) may be eliminated from the minimized representation. In other embodiments, the minimized representation does not lose any detail, but is just made smaller in size to permit viewing multiple representations.

In additional embodiments of the invention, a simplified context representation may be used in the alternative to representations of multiple subjects located in a single environment.

Also, any embodiment configured to display more than one representation (including context representations or any multiple representation screen) may be configured to permit enlarging the representation. For example, in a multiple representation screen or context representation, if a user selects a representation, the representation may be enlarged, to take up the whole screen or a larger portion of the screen. The enlarged representation may be more detailed than the minimized representation or have the same level of detail. In certain embodiments, only a portion of a representation is enlarged for more detailed viewing.

A further embodiment of the invention provides a representation that can provide additional information regarding the subject. This additional subject information can be in the form of information presented as one or more layers or screens that provide one or more details from the surface of the body inwardly. Such additional information may be available by selecting a button symbol, by rolling a cursor over a specific portion of the representation, by flipping through multiple screens, by moving one screen out of view, by typing a command, or other method known in the art.

Certain embodiments of the present invention may include an information entry interface in which a user enters information about the subject. Information also may be received by a component of the system from a remote device or unit, for example, a treatment or monitoring device, patient identification device such as an RFID tag in a subject tag or bracelet, a medical records database, patient's personal database, insurance company database, or a health information database. The information may be sent and received using a communication channel accessed via a network interface (such as an Ethernet card or Ethernet cable), a communication port, a PCMCIA slot and card, wired or wireless systems (such as Wi-Fi, Bluetooth, Infrared), local area networks, wide area networks, intranets, etc. For purposes of this application, the term “remote” means distinct from the reference point, but does not require any specific distance.

Certain embodiments of the subject representation, context representation, and information entry interface will be made available for viewing or otherwise perceiving via a user interface depicted on a display component. Certain embodiments of a display component may be a part of a computer system or may be separate or separable from a computer system. A display component may be portable such that the user can carry it in a pocket, strap it to a belt loop, clip it to eyeglasses or a frame, or otherwise store close to the provider. Other embodiment of a display component are not configured to be portable, but are positioned to be viewed easily by the provider in a specific environment. Such non-portable embodiments of a display component may be configured to project the provider interface onto a wall or other surface. Examples of a display component include a monitor such as a computer monitor, television monitor, liquid crystal display, plasma, digital light processing monitor, light-emitting diode monitors, or surface-conducted electron-emitted monitors, touchscreen, projector, mobile device, mobile telephone device, pager, handheld device, personal digital assistant, goggles or other head-mounted unit such as a Google Glass™ unit, other wearable computer, or other electronic visual display units. A display component also may be mounted on helmet or other headwear of an emergency medical technician, field medic, soldier, or other health care provider.

Another non-portable embodiment of a display component may be configured to be a large monitor that is generally viewable from anywhere in the environment.

Certain embodiments of the present invention may be configured to provide security measures that comply with relevant health care laws regarding patient data and security, including, for example, the (1) Health Insurance Portability and Accountability Act (“HIPPA”) requirements for authentication and de-identification of records; (2) the HITSP/SC112 standard for healthcare document management including transfer via email, (3) FIPS 197 AES (Advanced Encryption Standard, a commonly used encryption standard, quite impenetrable), the (4) IHE ITI-TF Revision 4.0 Audit Trail and Node Authentication (ATNA) standard for auditing (if auditing functionality is needed), and foreign regulations or standards as well. Also, the present invention may include a security component such as data encryption, control of user access, biometric authentication, cryptographic authentication, digital rights management services, and other security protocols.

Certain embodiments are configured to permit more than one user to access a single screen or a single representation, sometimes at the same time. For example, a resident and a nurse may be providing care to the same group of patients, and may wish to edit or update information in the same screen.

Certain embodiments of the present invention also may include a messaging component such that if one user wishes to convey information to another user, a message may be sent or received. Such a message may be as simple as causing a change in an indicator or a change in a representation, or may be more complex such as a text-based or character based message. The message may appear, for example, in the same screen as the representation, as a pop-up over the representation screen, or in a separate screen.

Certain embodiments of the present invention may include a replay component configured to permit viewing historical information about the subject. Historical information may include indicators that were previously positioned relative to the representation related to the subject, information imported from an external information source, information entered into an information entry interface of the system, or a combination of information from various sources. In certain embodiments, activating the replay component causes the system to automatically show a video or a series of screens recounting the history of a subject during a specific hour, day, week, or month, history of a subject related to a specific event (e.g., surgery, labor and delivery, treatment course for a particular disease or symptom, or other event), history of entire stay in a specific department or facility, entire subject history, highlights of entire subject history, or other set of historical information related to a subject. The series of screens may include a series of indicators for the relevant time period, series of indicators positioned relative to a representation, series of representations, series of interpretations of the indicators (e.g., instead of displaying the actual indicator, words or more detailed information related to the meaning of the indicator may be displayed), or some combination. Certain embodiments of the replay component are configured to quickly and efficiently depict past information about a subject. Certain embodiments of the replay component are configured to depict a comprehensive set of information about a subject.

The present invention optionally may include a report component configured to assemble and/or export information to form a report. A report component may be configured to export report information to a document, email, notification, printer, facsimile machine, or other arrangement. A provider also may instruct the system or the system may be set up to automatically or optionally generate reports on a regular basis, for example, hourly, twice daily, daily, biweekly, weekly, bimonthly, monthly, etc. Each report may include only the information since the last report, may include all information since a certain point (e.g., all information since subject was checked in to that facility, all information since patient was transferred to a specific department), all information available in the system, or all information available in the system and available from external sources.

A report may include information configured as an indicator with or without the representation. In such embodiments, a legend that describes the meaning of each indicator also may be included in the report. A report also may include time stamps or date stamps related to when an indicator was added to a representation or when an indicator was removed from a representation in the system.

In certain reports, an indicator or group of indicators may be transcribed to be more readable or understandable outside of the system context. For example, instead of (or in addition to) displaying a heart attack indicator followed by a stent device indicator, the transcription in a report may read “The subject suffered a heart attack. A stent device was positioned in the subject's heart.”

Certain embodiments of the present invention include a voice command component configured to permit the system to receive and process voice commands from a user. Such embodiments may permit the user to enter information into the system by voicing a command. One such command may result in adding an indicator to a representation. Another command may result in adding an entry to a to-do list. An additional command may result in accessing information from an external source and having the system provide with an audible response. Yet another command may result in turning on or turning off an alert indicator. This list of commands is illustrative, and not intended to be exhaustive.

The present invention and its attributes and advantages will be further understood and appreciated with reference to the detailed description below of presently contemplated embodiments, taken in conjunction with the accompanying drawings.

### BRIEF DESCRIPTION OF THE DRAWINGS

The preferred embodiments of the invention will be described in conjunction with the appended drawings provided to illustrate and not to the limit the invention, where like designations denote like elements, and in which:

FIG. 1A illustrates an embodiment of the present invention including a subject representation screen.

FIG. 1B illustrates an embodiment of the present invention including a subject representation and an expanded indicator menu.

FIG. 2A illustrates an embodiment of the present invention including a subject representation screen.

FIG. 2B illustrates an embodiment of the present invention including a subject representation screen.

FIG. 3A illustrates an embodiment of the present invention including a subject representation screen.

FIG. 3B illustrates an embodiment of the present invention including a subject representation screen with a secondary information component.

FIG. 4A illustrates an embodiment of the present invention of a context representation.

FIG. 4B illustrates an embodiment of the present invention of a context representation in which one patient representation is enlarged.

FIG. 4C illustrates an embodiment of the present invention of a context representation.

FIG. 4D illustrates an embodiment of the present invention of a context representation.

FIG. 5A illustrates an embodiment of the present invention in which multiple subject representations are depicted in one screen.

FIG. 5B illustrates an embodiment of the present invention in which multiple subject representations are depicted in one screen.

FIG. 5C illustrates an embodiment of the present invention in which multiple subject representations are depicted in one screen.

FIG. 6A illustrates an embodiment of the system according to the present invention.

FIG. 6B illustrates an embodiment of the system according to the present invention.

FIG. 6C illustrates an embodiment of the system according to the present invention.

FIG. 6D illustrates an embodiment of the system according to the present invention.

FIG. 7 illustrates an embodiment of a computer system.

FIG. 8 illustrates an embodiment of a cloud computing system.

FIG. 9 illustrates a method embodiment of the present invention.

FIG. 10A illustrates an embodiment of a method according to the present invention.

FIG. 10B illustrates an embodiment of a method according to the present invention.

FIG. 11 illustrates an embodiment of a method according to the present invention.

FIG. 12A illustrates an embodiment of a method according to the present invention.

FIG. 12B illustrates an embodiment of a method according to the present invention.

FIG. 13 illustrates an embodiment of a method according to the present invention.

FIG. 14 illustrates an embodiment of a method according to the present invention.

### DETAILED DESCRIPTION OF EMBODIMENTS OF THE INVENTION

Certain embodiments of the present invention may provide one or more screens 18 that together form a program 16. For purposes of this application, the term “screen” means a “screenshot” or a portion of the program 16 which is viewable or perceivable via a display component at a given time.

One screen may include a subject representation 20, which is configured to permit a provider to identify quickly a particular area of the subject that is the focus of treatment or management efforts. A subject representation 20 may include a form outline 22, which generally represents the subject. A subject representation 20 also may include a subject's health and treatment history, known as “background section” 33. In certain embodiments, the subject's background section 33 may be configured to receive an indicator 30. A subject's background section 33 also may be configured to convey information by its color or design. For example, a red background color could indicate a dangerous condition.

An indicator 30 may include an affected area indicator 24. As illustrated in FIGS. 2A, 2B, 3A, and 3B, an affected area indicator 24 may be sized and shaped to convey information about the affected portion of the subject's body. Such affected area indicators 24 may include a heart indicator 24A, a brain indicator 24B, or any other part of the patient's body.

An indicator 30 may be selected for display from an indicator menu 14, including an indicator menu button 14A and indicator menu component 14B. The indicator menu component 14B may include an expanded indicator menu as illustrated in FIG. 1B. Once selected from the menu 14, the indicator 30 may be displayed in the subject representation screen 18A, possibly in an indicator field 15. In certain embodiments, the indicator field 15 may include general indicator fields 17, configured to permit display of indicators related to any information, or body information fields 26, configured to permit display of indicators related to a specific portion of the body and generally positioned near that body portion on the subject's representation, as illustrated in FIG. 2A. In certain embodiments, the indicators may be manipulated such as moved, rotated, highlighted, or other, while positioned in an indicator field 15.

As mentioned above, a subject representation 20 may be shown as a part of a page such as a patient representation screen 18A. Such screen 18A may include a header indicator field 28 configured to convey additional information about the patient that may not be associated with a specific portion of the body. Such header indicator fields 28 may include, for example, fields for a gender indicator 28A such as “Mars” and “Venus” symbols and a post-operative day field 28B, and a notes field 28C. A notes field 28C is configured to permit a user to enter free-form notes regarding the subject. A subject representation screen 18A also may include a comments field 34 that permits a provider to enter and view additional comments about a subject.

FIG. 2B illustrates an embodiment in which an expanded indicator menu 14B includes a first expanded indicator menu section 14B1 and a second expanded indicator menu section 14B2.

Certain embodiments of a subject representation screen 18A also may include a navigation menu 36. A navigation menu 36 may include a home button 36A, a save button 36B, and a discharge button 36C. Upon selection, a home button 36A may cause the display of a “home screen” of the system. A home screen may include a context representation screen 18B, a screen that displays various options, or other. Upon selection, a save button 36B may cause information displayed in the patient representation screen 18A to be saved for later viewing or editing. Upon selection, a discharge button 36C may cause one or more of a number of actions. For example, a discharge button 36C may cause deletion of the information available in the screen 18, may cause the screen 18 to reset to a blank template screen, may trigger sending the information in the screen 18 to an information storage unit, or may cause the patient to be removed from a list of patients that are currently being managed. A navigation menu 36 also may include a refresh button that, upon selection, may cause updating of all information displayed in the screen, or may trigger sending an information request to sources such as a computer system, database, server, or a device.

FIG. 3A includes another embodiment of a subject representation screen 18A. The illustrated embodiment includes a gender indicator field 28A, a post-operative day field 28B, and a notes field 28C. FIG. 3A also includes a first scrolling indicator menu 19A and a second scrolling indicator menu 19B configured to permit provider selection of an indicator 30 and viewing a wide variety of indicators 30. The indicators 30 may be categorized by body part, by provider specialty, by alphabetical order, by frequency of use, or other characteristic in each indicator menu. In certain embodiment, the indicators 30 may be selected from the indicator menu and then positioned anywhere in the patient representation 20 and is not limited to a specific field.

The illustrated embodiment shows examples of indicator 30 types. Specifically, a bacteria indicator 30A is configured to convey information about antibiotics, infection locations, bacterial infection sources, and tracking course of antibiotic treatment.

An epilepsy indicator 30B may be configured to convey information about epilepsy medications, tracking of seizure events, and history of electroencephalograms.

A medical record indicator 30C may be configured to convey information in a patient's medical records.

A pain indicator 30D, 30E may be configured to convey information about the pain a patient is experiencing.

A device indicator, specifically, a pacemaker indicator 30F or a triple-lumen central intravenous catheter indicator 30G, may be positioned relative to the subject representation to convey the actual position relative to the subject.

A microorganism indicator 30H may be used to convey information about an infection or other ailment related to a microorganism.

A reference indicator 30J may be used to permit a user to access reference materials regarding treatment protocols, manual of algorithms, and other data. Certain reference materials may be stored in the system 10, the computer system 50, or an external database 78.

A sleep indicator 30K may be used to indicate information about the subject's sleep patterns.

As illustrated in FIG. 3B, certain embodiments of an indicator 30 include a secondary information component 32 configured to convey more information than is available by perceiving the indicator 30 alone. One or more secondary information components 32 may be associated directly with an indicator or a subject representation. Certain embodiments of a secondary information component 32 may include an extended display accessed through, for example, a hover feature (e.g., hovering a mouse cursor or equivalent over an indicator) or a selection feature (e.g., clicking, touching, pushing, hyperlinking, or otherwise choosing the indicator). The secondary information component 32 may permit a provider to enter and view individualized information about the indicator 30 or the underlying treatment or management efforts with which it is associated relative to the subject. For example, the more detailed information displayed in the secondary information component may include patient images (e.g., X-ray image, ultrasound image, CT scan image, MRI image, or other radiological imaging), non-subject images related to the subject's condition, or descriptions related to the subject). As another example, certain embodiments permit a user to view the x-ray of a subject's broken bone by selecting a broken bone indicator in the subject representation.

The embodiment illustrated in FIG. 3B includes a first secondary information component 32A and a second secondary information component 32B. The first secondary information component 32A is configured to display text only related to the infection indicator, while the second secondary information component 32B is configured to display an indicator only (specifically, a pharmacy indicator representing pills generally or, specifically, Aspirin treatment related to a heart indicator). However, certain embodiments of a secondary information component 32 may be configured to include both textual information and symbolic information in the form of an indicator.

Other embodiments of a secondary information component 32 are configured to permit viewing general, non-individualized information that may be relevant to the indicator 30 or the underlying treatment or management efforts with which it is associated. A secondary information component 32 may be accessible only while the indicator is positioned in a menu, relative to a subject representation, in an indicator field, or any combination.

In certain embodiments, a user may enter information in a secondary information component by, for example, electing from a number of choices expressed as text or symbols (e.g., indicators), typing characters into a field, positioning an indicator relative to a representation or field, selecting options from a drop down menu, checking a box field, selecting a combination of keys (e.g., alt-R, ctrl-T), using a finger or a stylus to write an instruction, code, or abbreviation on a representation, voice command, or other methods known in the art. Certain embodiments are configured to permit rapid input of information into a secondary information component and/or to permit hands-free input of information.

Indicators 30 such as affected area indicators 24 also may include a secondary information component 32. For example, a heart indicator 24A may include a secondary information component 32 configured to permit entering and viewing of, for example, cardiovascular medications, cardiac function, and blood pressure goals. A brain indicator 24B may include a secondary information component 32 configured to permit entering and viewing of, for example, neurologic medications.

Certain embodiments of an indicator 30 do not include a secondary information component 32 and simply convey that which can be perceived from the indicator 30.

Certain embodiments of an indicator 30 include a hyperlink feature, such that upon selection of the indicator 30, an external source of information may be accessed or displayed. For example, upon selecting a reference indicator 30J, a provider may open an external or internal reference manual, reference database, website, or other source of information. A medical record indicator 30C may open an interface for editing or viewing a medical records system that accessible via certain embodiments of the present invention.

The embodiment illustrated in FIG. 3A also includes various status fields 23 configured to convey generally numeric information about some aspect of the subject's status. For example, the illustrated embodiments include strength status fields 25 that convey a motor strength assessment. Specifically, the illustrated embodiment includes a first arm strength status field 25A, second arm strength status field 25B, first leg strength status field 25C, and a second leg strength status field 25D. In other embodiments, a status field 23 may be configured for a specific specialty or subject (e.g., dilation of a subject in labor, flexibility of a patient in physical therapy, etc.).

The embodiment illustrated in FIG. 3B also illustrates an objective field 27. An objective field 27 may be configured to convey information about a goal for the subject. The illustrated embodiments show systolic blood pressure objective fields 29, including a lower limit systolic blood pressure objective field 29A and an upper limit systolic blood pressure objective field 29B. In other embodiments, an objective field 27 may be configured to convey information about diastolic blood pressure goals, pain goals, weight goals, flexibility goals, strength goals, heart rate goals, communication goals, and any other goals.

FIG. 3A and FIG. 3B also include a transfer feature configured to permit a first provider to send and receive information about a subject relative to a second provider. In certain embodiments, selecting a transfer icon 35 permits transferring some or all of subject's recorded representations from a first to a second provider. Such a function would be useful, for example, when a second provider takes over the care and treatment of the subject from the first provider in a treatment facility (i.e., handoff to new shift). Upon transfer, the subject information may be saved or may be deleted by the second provider with respect to what was delivered by the first provider.

As illustrated in FIG. 4A, certain embodiments of the present invention include a context representation screen 18B in which a context representation 40 is shown. The simplified context representation 40 may show the subject as a subject representation 20 in such location relative to another or other subjects 20. Advantageously, the context representation 40 allows each of the subjects to be identified simply by location. The illustrated embodiment includes a first subject representation 20A, a second subject representation 20B, a third subject representation 20C, a fourth subject representation 20D, a fifth subject representation 20E, and a sixth subject representation 20F, each illustrated in a specific location relative to the other.

Context representation screens 18B also may include environmental representations 42 configured to provide information about environmental reference points. Environmental reference points are items or easily identifiable reference points that assist the user in perceiving the location of the subject relative to the reference point. Environmental reference points also permit the user to determine the appropriate orientation for the context representation screen 18b relative to the environment 41. For example, a door representation 42A and a number of bed representations 42B are illustrated in FIG. 4A. Other embodiments of environmental representations 42 may identify environmental reference points such as a hallway, window, desk, table, nurse's station, room, closets, sidewalks, plants, vehicles, roadways, monuments, buildings, other patients, or anything else in the actual environment of the subject.

FIG. 4B illustrates a context representation screen 18B in which one of the subject representations 20 is enlarged to permit, for example, viewing more detailed information or editing the subject representation.

The embodiment illustrated in FIG. 4C includes gender-specific subject representations 21 sized and shaped to convey gender information. Specifically, the female gender 21A is displayed with what appears to be a dress, while the male gender 21B is displayed with what appears to be pants.

Certain embodiments of a subject representation 20 in a context representation 40 may include a connecting feature configured to connect the subject representation screen 18A with the subject representation in the context representation screen 18B. In such embodiments, upon selecting the subject representation 20 in the context representation screen, a subject representation screen 18A is displayed.

FIG. 4C also illustrates environmental reference points 42 including a bed 42B and a hallway 42C.

FIG. 4D illustrates an embodiment of a context representation screen 18B having multiple bed representations 42B, each of which can be selected to reveal a subject representation corresponding to the bed. Certain embodiments of a context representation screen 18B that do not include a subject representation, such as that shown in FIG. 4D, may be configured to include indicators 30 positioned relative to the subject's bed representation.

FIG. 5A-FIG. 5C illustrate embodiments in which multiple subject representations are depicted in one screen—which are termed a multiple subject representation screen 43. In FIG. 5A, the first representation 20A depicts a first view of a subject and a second representation 20B depicts a second view of the same subject. However, in other embodiments, each representation depicts a different subject.

In FIG. 5A and FIG. 5B, the subject representations 20 are generally equally sized in the screen 43. In FIG. 5C, the first subject representation 20A is sized larger than the second subject representation 20B and the third subject representation 20C, the latter two of which are generally equally sized. In the embodiment illustrated in FIG. 5C, the user may size and arrange the positions manually, or the size and arrangement may be a result of a priority determination (e.g., the patient depicted in the first representation 20A has the highest priority for attention, while the patients depicted in the second representation 20B and third representation 20C are tied for the second highest priority for attention).

As mentioned above, a group of screens 18 including, for example, the subject representation screen 18A, the context representation screen 18B, multiple subject representation screen, home screen, information entry interface screen, provider information screen, legal/licensing rights screen, manufacturer information screen, other screens, algorithms, and other data together form what is termed a “program” 16 for purposes of this application.

FIG. 6A illustrates a system embodiment 10 of the present invention including a computer system 50 on which the program 16 may be stored directly on the main memory 58 or secondary memory 60 of the computer system 50. Certain embodiments of the computer system 50 include an input/output interface 52 such as a display component 70 or other components described below.

FIG. 6B illustrates an embodiment of the system 10 configured to communicate with a remote display component 70 via a wireless or wired communication channel 72. Certain embodiments of the present invention also may include a system 10 configured to permit communication via a wireless or wired communication channel 72 among units such as computer system 50, remote display component 70, treatment or monitoring device 74, a database 78 including a database stored on a computer readable medium or in a second computer system, and a server 76. In the embodiment illustrated in FIG. 6C, information may flow between any of the units and the computer system 50, but does not flow between or among the units. In other embodiments, information may flow between and among the units, such as from the treatment/monitoring device 74 directly to the remote display component 70, as illustrated in FIG. 6D. Also, reverting back to that which is illustrated in FIG. 6C, the program 16, or at least parts of the program may be stored on a server 76 in certain embodiments.

FIG. 7 illustrates an exemplary computer system 50 that may be used as part of the system 10 and to implement the methods according to the invention. One or more computer systems 50 may be included in the system 10 and may carry out the methods presented herein as computer code.

A computer system 50 includes an input/output interface 52 connected to communication infrastructure 54—such as a bus—, which forwards data such as graphics, text, and information, from the communication infrastructure 54 or from a frame buffer (not shown) to other components of the computer system 50. The input/output interface 52 may be, for example, a keyboard, touch screen, joystick, trackball, mouse, monitor, display component, remote display component, screen, speaker, printer, any other computer peripheral device, or any combination thereof, capable of entering and/or viewing data.

A computer system 50 includes one or more processors 56, which may be a special purpose or a general-purpose digital signal processor that processes certain information. Computer system 50 also includes a main memory 58, for example random access memory (“RAM”), read-only memory (“ROM”), mass storage device, solid-state drive, or any combination thereof. Computer system 50 also may include a secondary memory 60 such as a hard disk unit 62, a removable storage unit 64, solid-state drive, or any combination thereof. Computer system 50 also may include a communication interface 66, for example, a modem, a network interface (such as an Ethernet card or Ethernet cable), a communication port, a PCMCIA slot and card, wired or wireless systems (such as Wi-Fi, Bluetooth, Infrared), local area networks, wide area networks, intranets, etc.

It is contemplated that the main memory 58, secondary memory 60, communication interface 66, or a combination thereof, function as a computer usable storage medium, otherwise referred to as a computer readable storage medium, to store and/or access computer software including computer instructions. For example, computer programs 16 or other instructions may be loaded into the computer system 50 such as through a removable storage device, for example, a floppy disk, ZIP disks, magnetic tape, portable flash drive, optical disk such as a CD or DVD or Blu-ray, Micro-Electro-Mechanical Systems (“MEMS”), nanotechnological apparatus. Specifically, computer software program 16 including computer instructions may be transferred from the removable storage unit 64 or hard disk unit 62 to the secondary memory 60 or through the communication infrastructure 54 to the main memory 58 of the computer system 50.

The communication interface 66 allows software, instructions and data to be transferred between the computer system 50 and external devices or external networks. Software, instructions, and/or data transferred by the communication interface 66 are typically in the form of signals that may be electronic, electromagnetic, optical or other signals capable of being sent and received by the communication interface 66. Signals may be sent and received using wire or cable, fiber optics, a phone line, a cellular phone link, a Radio Frequency (“RF”) link, wireless link, or other communication channels.

Computer programs 16, when executed, enable the computer system 50, particularly the processor 56, to implement the methods of the invention according to computer software including instructions. The computer system 50 described herein may perform any one of, or any combination of, the steps of any of the methods presented in this application. It is also contemplated that the methods according to the invention may be performed automatically, or may be invoked by some form of manual intervention.

The computer system 50 may be configured as a desk top computer, a laptop, a netbook, a handheld computer including, for example, a personal digital assistant (“PDA”), smart hand-held computing device, cellular telephone, or, hand held console or MP3 player, tablet, or similar hand held computer device, such as an iPad®, iPod Touch® or iPhone®.

The computer system 50 of FIG. 7 is provided only for purposes of illustration, such that the invention is not limited to this specific embodiment. It is appreciated that a person skilled in the relevant art knows how to program and implement the invention using any computer system.

FIG. 8 illustrates an exemplary cloud computing system 80 that may be used to implement the methods according to the present invention. The cloud computing system 80 includes a plurality of interconnected computing environments. The cloud computing system 80 utilizes the resources from various networks as a collective virtual computer, where the services and applications can run independently from a particular computer or server configuration making hardware less important.

Specifically, the cloud computing system 80 includes at least one client computer 82, which may include a computer system 50 as described above. The client computer 82 may be any device through the use of which a distributed computing environment may be accessed to perform the methods disclosed herein, for example, a traditional computer, portable computer, mobile phone, personal digital assistant, tablet to name a few. The client computer 82 includes memory such as random access memory (“RAM”), read-only memory (“ROM”), mass storage device, or any combination thereof. The memory functions as a computer usable storage medium, otherwise referred to as a computer readable storage medium, to store and/or access computer software and/or instructions.

The client computer 82 also includes a communications interface, for example, a modem, a network interface (such as an Ethernet card), a communications port, a PCMCIA slot and card, wired or wireless systems, etc. The communications interface allows communication through transferred signals between the client computer 82 and external devices including networks such as the Internet 72A and cloud data center 86. Communication may be implemented using wireless or wired capability such as cable, fiber optics, a phone line, a cellular phone link, radio waves or other communication channels.

The client computer 82 establishes communication with the Internet 72A—specifically to one or more servers—to, in turn, establish communication with one or more cloud data centers 86. A cloud data center 86 includes one or more networks 90a, 90b, 90c managed through a cloud management system 88. Each network 90a, 90b, 90c includes resource servers 92a, 92b, 92c, respectively. Servers 92a, 92b, 92c permit access to a collection of computing resources and components that can be invoked to instantiate a virtual machine, process, or other resource for a limited or defined duration. For example, one group of resource servers can host and serve an operating system or components thereof to deliver and instantiate a virtual machine. Another group of resource servers can accept requests to host computing cycles or processor time, to supply a defined level of processing power for a virtual machine. A further group of resource servers can host and serve applications to load on an instantiation of a virtual machine, such as an email client, a browser application, a messaging application, or other applications or software.

The cloud management system 88 can comprise a dedicated or centralized server and/or other software, hardware, and network tools to communicate with one or more networks 90a, 90b, 90c, such as the Internet or other public or private network, with all sets of resource servers 92a, 92b, 92c. The cloud management system 88 may be configured to query and identify the computing resources and components managed by the set of resource servers 92a, 92b, 92c needed and available for use in the cloud data center 86. Specifically, the cloud management system 88 may be configured to identify the hardware resources and components such as type and amount of processing power, type and amount of memory, type and amount of storage, type and amount of network bandwidth and the like, of the set of resource servers 92a, 92b, 92c needed and available for use in the cloud data center 86. Likewise, the cloud management system 88 can be configured to identify the software resources and components, such as type of Operating System (“OS”), application programs, and the like, of the set of resource servers 92a, 92b, 92c needed and available for use in the cloud data center 86.

The present invention is also directed to computer products, otherwise referred to as computer program products, to provide software to the cloud computing system 80. Computer products store software on any computer useable medium, known now or in the future. Such software, when executed, may implement the methods according to certain embodiments of the invention. Examples of computer useable mediums include, but are not limited to, primary storage devices (e.g., any type of random access memory), secondary storage devices (e.g., hard drives, floppy disks, CD ROMS, ZIP disks, tapes, magnetic storage devices, optical storage devices, Micro-Electro-Mechanical Systems (“MEMS”), nanotechnological storage device, etc.), and communication mediums (e.g., wired and wireless communications networks, local area networks, wide area networks, intranets, etc.). It is to be appreciated that the embodiments described herein may be implemented using software, hardware, firmware, or combinations thereof.

The cloud computing system 80 of FIG. 8 is provided only for purposes of illustration and does not limit the invention to this specific embodiment. It is appreciated that a person skilled in the relevant art knows how to program and implement the invention using any computer system or network architecture.

As illustrated in FIGS. 9-13, embodiments of the present invention also include method embodiments 100.

As illustrated in FIG. 9, certain embodiments of a method 100 include accessing a computer system 102. Next, a program is built, which may include generating one or more interface parameters for subject identification 104, constructing indicators such as affected area indicators and device indicators related to subject or environment 106, and configuring a network and authentication parameters 108. Step 104 may include permitting a user to define the floor plan of the subject's locations or permit for identification of location using different means. Step 106 may include permitting the provider to select from a number of predefined indicators and action types. Step 108 may include setting up passwords for the program or computer system, configuring secure authentication protocols with a server, and defining parameters for interoperability with an existing electronic medical records database, among others. Upon completion of steps 104, 106, and 108 (which may or may not be conducted in the order identified), users are given access to the program for use with the subjects.

As illustrated in FIG. 10A and FIG. 10B, certain embodiments of a method 100 may include providing a subject representation configured to permit a provider to perceive quickly and easily information about a subject 112, wherein information selected from the group of affected area information, device information, critical information, and identifying information is displayed using at least one or more indicators 114.

An indicator menu including one more indicators may be offered to permit a provider to select indicators relevant to the subject, and the selected indicators are shown in an indicator field 116. Certain embodiments may include an indicator menu that is integrated with the subject representation such that if a user wishes to add an indicator related to the subject's head, as an example, the provider selects the head portion of the subject representation. In other embodiments, the indicator menu is positioned in the same screen as the subject representation, but not integrated in the subject representation.

One or more subject representations may be organized relative to one another or relative to an environment to form a context representation, wherein each subject may be identified by its position 118. Also, embodiments of the present method permit sending and receiving information by and between external display components, devices, databases, computer systems, and servers 120.

As illustrated in FIG. 11, a method 100 according to the present invention may include various steps. The system may obtain subject information about each of the one or more subjects 122. An indicator is assigned to signify the subject information 124. A subject representation is selected for the each of the one or more subjects 126. Information is conveyed about the one or more subjects on the display on which the one or more representations are shown through use of an indicator 128. The indicator is presented on a display relative to the subject representation to permit quick and easy observation of the subject information 130.

Additional method embodiments 100 are illustrated in FIG. 12A-FIG. 12B. In such embodiments, a context representation is determined for the one or more subjects relative to one or more environmental reference points 132. An indicator is designated to identify the one or more subjects 134. Information is then obtained relative to the one or more subjects 136. Information about the one or more subjects is then conveyed through assignment of one or more representations 138. The subject representations relative to the context representations are then organized 140. The environmental reference points and the one or more subject representations associated with the one or more environmental reference points are the presented on a display 142. A subject representation may be enlarged to permit illustrating a more detailed version of the representation 144. The representation indicators may then be modified (although, in certain embodiments, the normal sized subject representation is also detailed and modifiable) 146. Then, the enlarged subject representation may be minimized back to the original size 148 and a view of the environmental reference point with one or more subjects may be viewed simultaneously.

As illustrated in FIG. 13, in certain embodiments of a method 100 according to the present invention, two or more subject representations are depicted in a single screen (possibly in a screen without environmental reference points) 150. Such embodiments also may include designing a function that permits enlarging and minimizing at least one of the subject representations 152 and subsequently enlarging 154 and minimizing 156 the subject representations.

As illustrated in FIG. 14, certain embodiments of a method 100 include providing a subject representation 112, capturing or retrieving an actual image of a subject 160, storing the actual image of a subject in program or on computer system 164, integrating the actual image of the subject into the subject representation, and then returning to view of the subject representation 166.

While the disclosure is susceptible to various modifications and alternative forms, specific exemplary embodiments of the present invention have been shown by way of example in the drawings and have been described in detail. It should be understood, however, that there is no intent to limit the disclosure to the particular embodiments disclosed, but on the contrary, the intention is to cover all modifications, equivalents, and alternatives falling within the scope of the disclosure as defined by the appended claims.

What is claimed is:

1. A computer-implemented method configured to facilitate management and treatment one or more subjects, comprising the steps of:
obtaining subject information about one or more subjects;
signifying the subject information through one or more indicators;
selecting a subject representation for the each of the one or more subjects for presentation on a computer display;
conveying information about the one or more subjects through display of the one or more indicators to facilitate management and treatment of the one or more subjects; and
presenting on a display the information relative to the one or more subject representations.

2. The method of claim 1, wherein an indicator is configured as an affected area indicator.

3. The method of claim 1, wherein the indicator is configured as a device indicator.

4. The method of claim 1, wherein the indicator is configured as a critical information indicator.

5. The method of claim 1, wherein the indicator is configured as a provider-focused information indicator.

6. The method of claim 1, wherein the indicator includes a secondary information component configured to convey more information than is available by perceiving the indicator alone.

7. The method of claim 1 further comprising the step of customizing the subject representation to form an avatar.

8. The method of claim 1 further comprising the step of generating a to-do list entry.

9. The method of claim 1 further comprising the step of exporting subject information into a report.

10. The method of claim 1 further comprising the step of employing a voice command component to make changes to the subject representation.

11. A computer-implemented method configured to facilitate management and treatment of one or more subjects, comprising the steps of:
determining a context representation for the one or more subjects relative to one or more environmental reference points;
designating an indicator to identify the one or more subjects;
obtaining information about the one or more subjects;
assigning a second indicator to the information about the one or more subject;
organizing a subject representation relative to the each of the one or more environmental reference points; and
presenting on a display the information relative to environmental reference points and the one or more subject representations associated with the one or more environmental reference points.

12. The method of claim 11, further comprising the step of enlarging the subject representation to permit viewing the subject representation in more detail.

13. The method of claim 11, further comprising the step of enlarging the subject representation to permit modifying the subject representation.

14. The method of claim 13, wherein modifying the subject representation includes positioning the indicator relative to the subject representation.

15. The method of claim 14, wherein an indicator is configured as an affected area indicator.

16. The method of claim 14, wherein the indicator is configured as a device indicator.

17. The method of claim 14, wherein the indicator is configured as a critical information indicator.

18. The method of claim 14, wherein the indicator is configured as a provider-focused information indicator.

19. A system to facilitate management and treatment of one or more subjects, comprising:
a processor;
a main memory in communication with the processor via a communication infrastructure and storing instructions that, when executed by the processor, cause the processor to:
obtaining information about one or more subjects;
assigning an indicator to signify the subject information;
selecting a subject representation for the each of the one or more subjects;
conveying information about the one or more subjects on the one or more representations through use of an indicator; and
presenting on a display the information relative to the one or more subject representations.

20. A system to facilitate managing and treating one or more patients, comprising:
a processor;
a main memory in communication with the processor via a communication infrastructure and storing instructions that, when executed by the processor, cause the processor to:
determining a context representation for the one or more subjects relative to one or more environmental reference points;
designating an indicator to identify the one or more subjects;
obtaining information about each of the one or more subjects;
assigning a second indicator to signify the subject information;
organizing the subject representation relative to the each of the one or more environmental reference points; and
presenting on a display the information relative to the one or more environmental reference points and the one or more subject representations associated with the one or more environmental reference points.
